(19) United States
(12) Patent Application Publication
(10) Pub. No.: US 2007/0245618 A1
(43) Pub. Date: Oct. 25, 2007

(54) Soft impact, rotating jaw animal trap

(76) Inventors: Larry Edward Pedersen, Ekalaka, MT (US); William Edward Pedersen, Duluth, MN (US)

Correspondence Address: William E. Pedersen, 5739 Pine Circle Dr., Duluth, MN, 55811, US

(21) Appl. No.: 11/406,868

(22) Filed: Apr. 20, 2006

(51) Int. Cl. A01M 23/26

(52) U.S. Cl. 43/90; 43/88

(57) ABSTRACT

Disclosed is an animal trap with a rotating auxiliary jaw subassembly attached to each of two substantially U-shaped trap main jaws. The invention is such that it reduces the impact force with an animal's leg upon closing. Additionally, the invention allows for increased holding power when the animal pulls away from the trap, but allows for reduced clamping force upon animal relaxation with the intent of allowing restored blood flow to the clamped area of the animal's extremity. Preferred embodiments include a padded jaw construction for additional reduction in impact force.

### CROSS-REFERENCE TO RELATED APPLICATION

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates to traps for catching wild animals with reduced chance of injury to the animals, while improving the likelihood of holding the animal.

In the past, there have been many attempts at creating traps with reduced risk of injury to the animal, [U.S. Pat. Nos. 6,751,901; 6,732,471; 4,817,313; 4,711,049; 4,638,590; 2,083,451; 1,913,893; 1,907,360]. Many of these concepts have involved the use of a snare type trap in which damage to the animal is reduced specifically during trap actuation or closing on the animal's leg. None of these traps have proven to be effective in terms of long term operation for capturing and holding the animals.

While traps have taken many forms throughout their history, [U.S. Pat. Nos. 6,832,447; 6,032,405; 5,907,922; 5,736,203; 5,109,627; 5,109,626; 4,557,067; 4,557,066; 4,555,863; 3,534,493; 2,216,927; 1,913,893; 1,577,000; 1,570,578; 1,461,743; 1,012,386; 440,336] the basic concept of two opposing U-shaped jaws with a spring clamping mechanism have proven to be the most effective for capturing and holding animals, [U.S. Pat. Nos. 4,972,626; 4,622,774; 4,486,972; 4,240,223; 4,479,324; 4,045,905; 2,020,153; 1,630,419; 1,391,570; 716,255]. While two opposing U-shaped jaws have proven effective in capturing and holding animals, there is a risk of injury to the animal.

Other patents have attempted to incorporate reduced injury to the U-shaped opposing design through the use of a rubber, or compliant jaw covering, [U.S. Pat. Nos. 870,251; 1,825,193; 2,146,464; 3,939,596; 4,175,351; 4,184,282]. While these traps represent a significant improvement for impact damage when the trap closes on the animal, they fail to address two specific problems. First, the holding power of these traps is insufficient. Secondly, the rubber jaw lining conforms to the animal's leg, and forms an effective barrier to blood flow to the lower extremity. This results in loss of feeling to the limb, allowing the animal to damage itself in an effort to escape.

Two trap innovations have dealt with the ability to increase the clamping force on an animal's leg. U.S. Pat. No. 2,128,579—attempts to accomplish this with slots on the main jaws and an auxiliary jaw which slides in those slots. The primary shortcomings of this design are that 1) the slots would tend to plug up with dirt during operation, rendering the trap ineffective, and 2) there is no attempt to reduce the impact damage to the animal extremity. U.S. Pat. No. 2,316,970 attempts to regulate the trap holding power through the use of levers applied to the trap retention chain. The problem with this design is that animal does not pull in a direct line at all times, therefore allowing the holding force of the trap to be ineffective in other than ideal pulling conditions.

### BRIEF SUMMARY OF THE INVENTION

The principal objective of this invention is to address the limitations of existing trap models, specifically: reduced likelihood of impact damage to the animal, increased holding power, and reduced likelihood of circulation reduction to trapped animal extremities. The trap design incorporates two U-shaped opposing jaws which do not contact the animal. Two auxiliary jaws provide the clamping contact with the animal. These auxiliary jaws are allowed to rotate on the main jaws. The design of the auxiliary jaws provides for additional functionality over existing traps. The auxiliary jaws are covered with rubber or some other compliant material to reduce impact shock to the animal upon clamping. The rotation of the auxiliary jaws absorbs additional impact energy upon striking the animal's extremity, aided by an auxiliary spring located in the auxiliary jaw subassembly. The auxiliary jaw rotation serves two additional purposes. The center of rotation is such that as the animal pulls outward from the center of the trap, the auxiliary jaws cam closer together and provide added holding power. After the animal tires and relaxes, the auxiliary jaws are allowed to cam outward and reduce clamping force, therefore allowing circulation to be restored to the extremity of the animal beyond the clamping point. No previous design incorporates the rotating camming auxiliary jaws allowing this invention to have superior and unique performance compared with all previous trap models.

### BRIEF DESCRIPTION OF DRAWING FIGURES

FIG. 1 shows a composite isometric view of the preferred embodiment of the trap assembly in the closed or sprung position.

FIG. 2 shows a plan view of the preferred embodiment of the trap assembly in the open or set position.

FIGS. 3 a) and b) show the preferred embodiment of the main trap jaws in the flat and formed state, respectively.

FIGS. 4 a) and b) show the preferred embodiment of the auxiliary jaws which rotate on the main jaws.

FIG. 5 shows the preferred embodiment of the spring between the jaws and the auxiliary jaws. The purpose of this spring is to maintain contact between the animal's extremity and the auxiliary during times when the animal is not pulling, and therefore camming the auxiliary jaws together.

FIG. 6 shows one embodiment of the compliant material extrusion used to cover the auxiliary jaws to assist in the soft impact with the animal's leg.

FIG. 7 shows the preferred embodiment of the retention plate used to hold the compliant material extrusion to the auxiliary jaws.

FIG. 8 shows a section view of the preferred embodiment of the auxiliary jaw subassembly.

FIG. 9 shows the preferred embodiment of the trap pan.

FIG. 10 shows the preferred embodiment of the trap body.

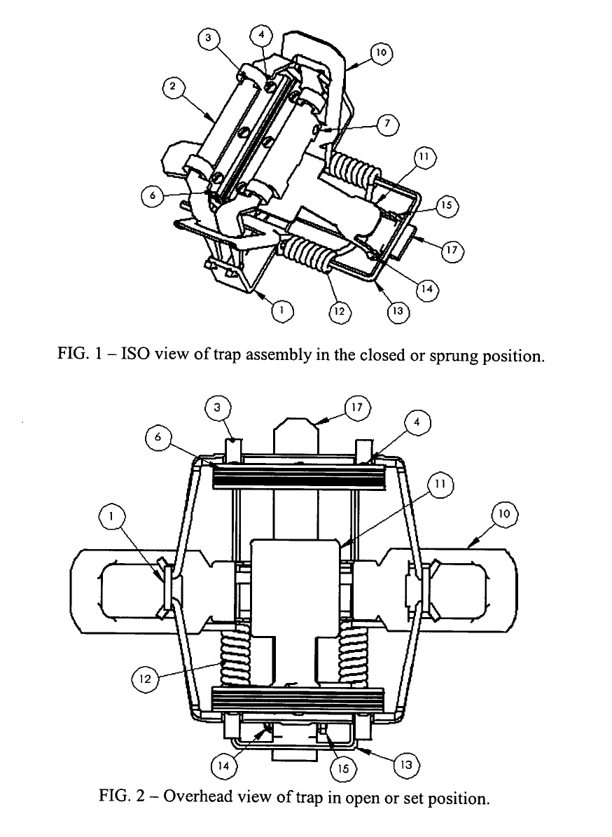

### DETAILED DESCRIPTION OF THE INVENTION

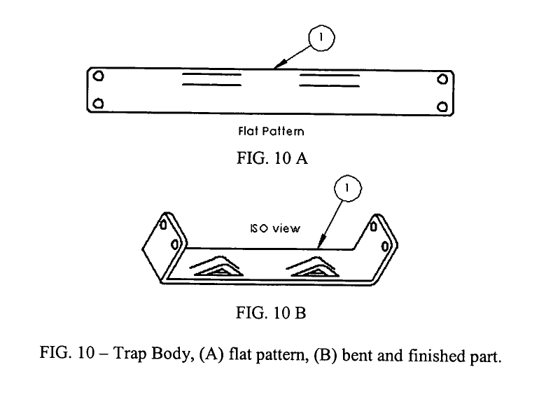

The majority of the components in this invention are to be formed using traditional heavy sheet metal construction techniques. Laser cutting, water jet cutting, electro-discharge machining, stamping, forming and machining are alternative processes that may be used. With respect to specific parts, the trap frame (1) as shown in FIG. 10 is formed typically through a stamping process to produce the flat shape, followed by drilling and slitting for notches to allow for installation of the spring retainer (13) and bending of the comers to form the finished part.

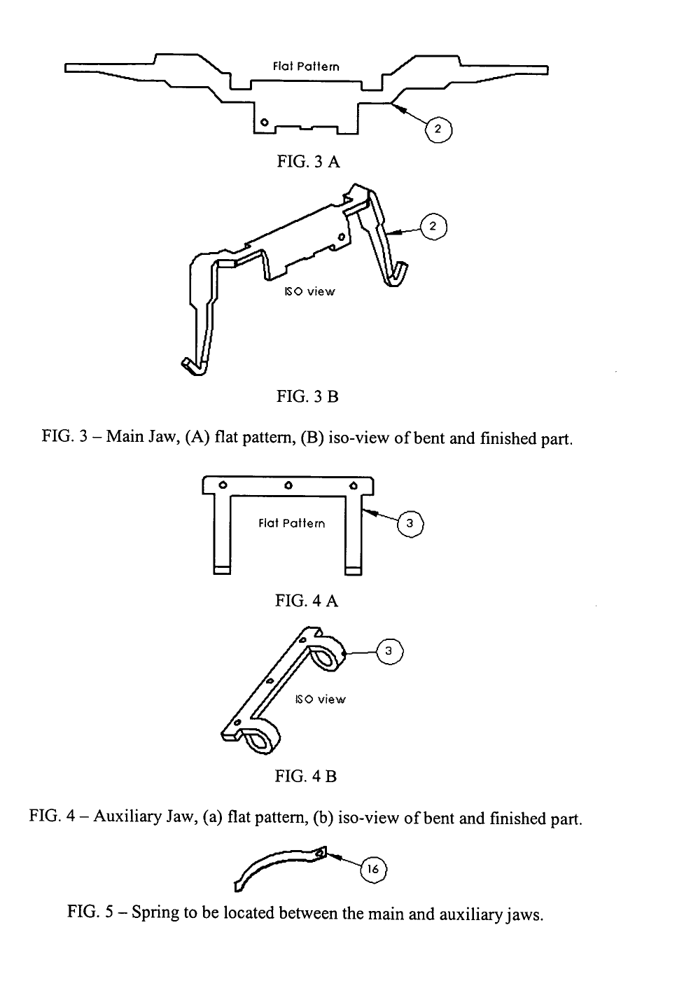

The substantially U-shaped main jaws are shown in detail in their preferred embodiment in FIG. 3. Two of these main jaws must be created for every trap assembly. The flat pattern is cut or stamped from a sheet of preferably steel, followed by bending processes to finish the part. Notches near the comers of the main jaw on the topmost corners will serve as rotation points for the auxiliary jaw subassembly. This rotation feature is unique to this trap and is one of the primary means of distinguishing this trap from prior art. The main jaws are rotationally mounted in pivot holes located in the trap frame (1). Upon closing, the main jaws will not contact one another at the center point, but only at points below the shoulder of the main jaws. This gap is important as the auxiliary jaw subassemblies will actually contact the animal to provide clamping force.

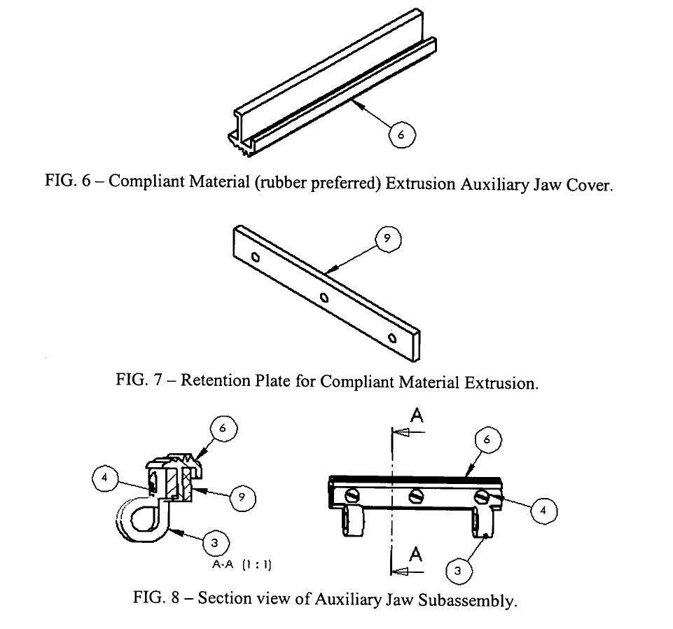

An auxiliary jaw subassembly as shown in FIG. 8 is rotationally mounted on the main jaws (2). The subassembly consists of the auxiliary jaws (3) shown in FIG. 4, the compliant material extrusion (6) shown in FIG. 6, and the retention plate or keeper (9) shown in FIG. 7 held together by multiple nuts and bolts passing through all subassembly pieces. The auxiliary jaw (3) flat pattern is cut or stamped, followed by bending of tabs around the main jaw (2) hinge points. The rotational union is preferably completed by tack welding the auxiliary jaw tabs to the auxiliary jaw body, preventing potential unbending during operation. The auxiliary jaw subassembly must be rotationally mounted on the main jaws (2) so that they are physically below the main jaws. This location provides a camming action to allow for increased holding force on animals attempting to pull out of the trap. The camming action also allows for the clamping force to be reduced to allow blood flow to be restored to the extremity of the animal when the animal is no longer applying outward force from the trap. This camming action is unique to this trap and provides additional functionality over all previously existing trap models.

The compliant material (6) shown in FIG. 6 is used to provide a cushioning effect between the contact points of the auxiliary jaws (3) and the animal's extremity upon trap actuation. The compliant material also reduces abrasion between the animal and the trap contact points. While previous trap models have incorporated padded jaws, none have also incorporated the camming action auxiliary jaw (3) concept. This is a significant improvement as the combination of the two provides for additional trap functionality not previously existing. The combination allows for blood flow to be restored to the extremity of the animal when the animal relaxes and quits pulling away from the trap. Previous models which do not incorporate the camming action do not allow for restored blood flow. As a result, feeling is lost to the animal's extremity, thus allowing the animal to use severe means to gain freedom from the trap, including chewing their extremity away from their body. The compliant material padding is preferably rubber of sufficient durometer and strength to sustain some wear as the animal chews on the outer edges of the material. This material is typically made using a rubber extrusion process, followed by cutting to length. Other processes could include thermoforming, rolling or injection molding.

The retention plate or keeper (9) shown in FIG. 7 is simply flat stock material that is cut to length and drilled for retention bolts to pass through. This plate (9) provides protection to the compliant material (6) so that the animal can not effectively chew on the compliant material covering and gain additional clearance for potential escape from the trap.

A coil spring or preferably flat spring (16) is to be installed between the auxiliary jaw (3) and main jaw (2) using a nut and bolt. This spring (16) provides sufficient force to allow the auxiliary jaw subassembly contact points through the compliant material (6) to maintain contact with the animal's extremities at all times following closure of the trap. It also allows for sufficient auxiliary jaw subassembly rotation to allow for restored blood flow to the animal extremity upon relaxation. This spring (16) is created through cutting or stamping, followed by forming to the finished part shape.

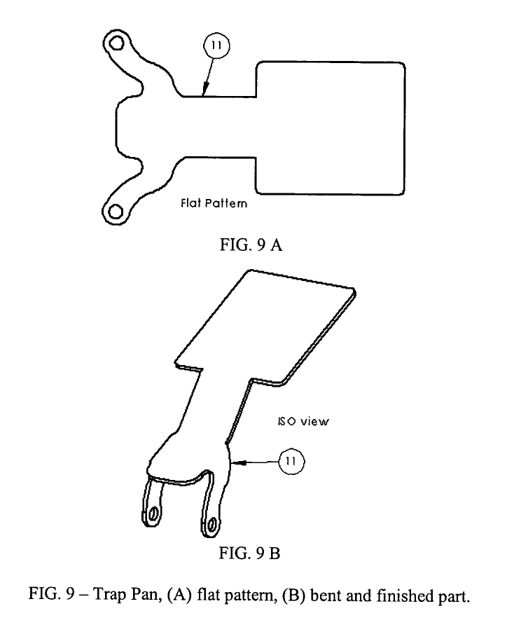

The trap pan (11) as shown in FIG. 9 is created through cutting or stamping followed by forming the final shape. This pan provides for retention of the main jaws (2) in the open or set position by hooking the main jaws and being held there by tension of the trap springs (12). When an animal steps on the pan (11) it is forced downward, releasing the main jaws (2), thus allowing the springs (12) to force the main jaws together with the auxiliary jaw subassemblies striking the animal and providing clamping force to the animal's extremity.

A means for attaching the trap to the ground or other restraining mechanism must be provided. This restraining mechanism will preferably be located near the center of the trap frame (1). Because this retention mechanism is not a unique feature to this trap, its detail has been omitted.

1-10. (canceled)

11. An animal trap, comprising:
two substantially U-shaped main jaws, each with rotating and camming auxiliary jaw subassemblies mounted on them, the jaw subassemblies each having an auxiliary jaw and a face that contacts an animal, wherein the rotating and camming auxiliary jaw subassemblies control a clamping force on the animal when the trap is in a closed position;
a trigger pan which locks the trap open in a set position;
a set of springs serving to actuate the main jaws which force them together upon release of the trigger pan;
two auxiliary springs, each located in a respective auxiliary jaw subassembly that aid in the rotation of the auxiliary jaw subassembly to maintain contact between the animal and the auxiliary jaws when the trap is in the closed position;
wherein the rotating auxiliary jaw subassembly are rotatable such that:
when the animal attempts to pull out of the trap, the rotating auxiliary jaw subassembly rotates and cams provide additional clamping force between the auxiliary jaws and an extremity of the animal; and
when the animal relaxes, the rotating and camming action of the auxiliary jaw subassembly allows for reduced clamping force and blood-flow restoration to the animal extremity.

12. The animal trap according to claim 11, wherein the faces of the auxiliary jaws comprise a padding of a compliant material.

13. The animal trap according to claim 11, wherein said auxiliary spring is a coil spring.

14. The animal trap according to claim 11, wherein said auxiliary spring is a flat spring.

15. The animal trap according to claim 11, wherein the auxiliary springs are located below a plane defined by a top surface of the main jaws when closed in a position providing partial protection of the spring from chewing damage from the animal.

16. An animal trap, comprising:
two U-shaped main jaws, each comprising:
a recess;
a rotating and camming auxiliary padded jaw subassembly mounted on a respective main jaw that controls a clamping force on an animal when the trap is in a closed position, the padded jaw subassembly comprising a padded auxiliary jaw;
an auxiliary spring located in the auxiliary padded jaw subassembly that aids in the rotation of the auxiliary jaw subassembly and maintains contact between the animal and the auxiliary jaw;
wherein:
when the main jaws are sprung to a closed position, the recesses allow only the rotating padded jaws to contact an extremity of the animal, the padded portion of the jaws and the secondary springs absorbing a shock of the jaws closing against the extremity in order to minimize animal trauma;
when the animal attempts to pull out of the trap, the rotating auxiliary jaw subassembly rotates and cams provide additional clamping force between the auxiliary jaws and the animal extremity; and
when the animal relaxes, the rotating and camming action of the auxiliary jaw subassembly allows for reduced clamping force and blood-flow restoration to the animal extremity.

17. The animal trap according to claim 16, wherein said auxiliary spring is a coil spring.

18. The animal trap according to claim 16, wherein said auxiliary spring is a flat spring.

19. The animal trap according to claim 16, wherein each auxiliary jaw comprises a plate or keeper that retains the jaw padding on the auxiliary jaw.

20. The animal trap according to claim 16, wherein the padded jaws are located below the main jaws in a position providing partial protection of the padding from chewing damage from the animal

21. The animal trap according to claim 16, wherein the auxiliary springs are located below a plane defined by a top surface of the main jaws when closed in a position providing partial protection of the spring from chewing damage from the animal.
